(19) United States
(12) Patent Application Publication
(10) Pub. No.: US 2022/0046471 A1
(43) Pub. Date: Feb. 10, 2022

(54) METHODS, APPARATUS AND SYSTEMS FOR DATA SEGMENTATION AND REASSEMBLY IN A WIRELESS COMMUNICATION

(71) Applicant: ZTE CORPORATION, Shenzhen (CN)

(72) Inventors: Feng XIE, Shenzhen (CN); Liping WANG, Shenzhen (CN); Tao QI, Shenzhen (CN); Jun XIONG, Shenzhen (CN)

(21) Appl. No.: 17/376,818

(22) Filed: Jul. 15, 2021

Related U.S. Application Data
(63) Continuation of application No. PCT/CN2019/072076, filed on Jan. 17, 2019.

(51) Int. Cl. H04W 28/06

(52) U.S. Cl. CPC H04W 28/065; H04W 80/02

(57) ABSTRACT

Methods, apparatus and systems for data segmentation and reassembly in a wireless communication are disclosed. In one embodiment, a method performed by a transmitter module in a wireless communication system is disclosed. The method comprises: segmenting a plurality of data units from a plurality of logical channels into a plurality of data segments at a medium access control (MAC) layer. The plurality of data segments are allocated with a plurality of sequence numbers in sequential order.

### CROSS-REFERENCE TO RELATED APPLICATION

This application claims the benefit of priority under 35 U.S.C. § 120 as a continuation of PCT Patent Application No. PCT/CN2019/072076, filed on Jan. 17, 2019, the disclosure of which is incorporated herein by reference in its entirety.

### TECHNICAL FIELD

The disclosure relates generally to wireless communications and, more particularly, to methods, apparatus and systems for data segmentation and reassembly in a wireless communication.

### BACKGROUND

The fourth Generation mobile communication technology (4G) Long-Term Evolution (LTE) or LTE-Advance (LTE-A) and the fifth Generation (5G) new radio (NR) mobile communication technology face more and more demands. Based on the current development trend, 4G and 5G systems are developing supports on features of enhanced mobile broadband (eMBB), ultra-reliable low-latency communication (URLLC), and massive machine-type communication (mMTC).

In an existing NR system, the radio link control (RLC) layer of the access network receives RLC service data units (SDUs) from an upper layer and adds a RLC sub-header to each RLC SDU to form RLC protocol data units (PDUs). The RLC layer segments the RLC SDUs that need to be segmented according to a scheduling result at the medium access control (MAC) layer, to generate RLC SDU segments. The RLC layer modifies the RLC SDU segment sub-headers, and delivers the RLC PDUs to the MAC layer. The MAC layer adds a MAC sub-header to each MAC SDU and concatenates the MAC SDUs into MAC PDUs. In the above NR system, data packet segmentation and reassembly at the layer 2 (L2) user plane have a low efficiency, which is difficult to meet the system performance requirements for fast processing.

Thus, existing systems and methods for data segmentation and reassembly in a wireless communication are not entirely satisfactory.

### SUMMARY OF THE INVENTION

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In one embodiment, a method performed by a transmitter module in a wireless communication system is disclosed. The method comprises: segmenting a plurality of data units from a plurality of logical channels into a plurality of data segments at a medium access control (MAC) layer. The plurality of data segments are allocated with a plurality of sequence numbers in sequential order.

In another embodiment, a method performed by a receiver module in a wireless communication system is disclosed. The method comprises: reassembling a plurality of data segments at a medium access control (MAC) layer to construct at least one of a plurality of reassembled data units for a plurality of logical channels. The plurality of data segments are allocated with a plurality of sequence numbers in sequential order.

In a different embodiment, a wireless communication node configured to carry out a disclosed method in some embodiment is disclosed. In yet another embodiment, a wireless communication device configured to carry out a disclosed method in some embodiment is disclosed. In still another embodiment, a non-transitory computer-readable medium having stored thereon computer-executable instructions for carrying out a disclosed method in some embodiment is disclosed.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1 illustrates an exemplary communication network in which techniques disclosed herein may be implemented, in accordance with an embodiment of the present disclosure.

FIG. 2 illustrates a block diagram of a base station (BS) and/or a user equipment (UE), in accordance with some embodiments of the present disclosure.

FIG. 3 illustrates a flow chart for a method performed by a BS or a UE for data segmentation as a transmitter module, in accordance with some embodiments of the present disclosure.

FIG. 4 illustrates a flow chart for a method performed by a BS or a UE for data reassembly as a receiver module, in accordance with some embodiments of the present disclosure.

FIG. 5 illustrates an exemplary method for data segmentation at a medium access control (MAC) layer, in accordance with some embodiments of the present disclosure.

FIG. 6 illustrates another exemplary method for data segmentation at a MAC layer, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

A typical wireless communication network includes one or more base stations (typically known as a “BS”) that each provides geographical radio coverage, and one or more wireless user equipment devices (typically known as a “UE”) that can transmit and receive data within the radio coverage. In the wireless communication network, a BS and a UE can communicate with each other via a communication link, e.g., via a downlink radio frame from the BS to the UE or via an uplink radio frame from the UE to the BS.

To meet the delay requirement for fast data processing, the present disclosure provides methods and systems for performing data segmentation at a medium access control (MAC) layer. In one embodiment, data units, e.g. service data units (SDUs), are segmented at a MAC layer of a transmitter module in a wireless communication system. The transmitter module may be either a BS or a UE. The SDUs are from a plurality of logical channels and are segmented into a plurality of data segments at the MAC layer which has a sequence number (SN). The plurality of logical channels are associated with the same SN of the MAC layer.

In one embodiment, the MAC layer supports data processing in a variety of granularities, including but not limited to: a Quality of Service (QoS) flow, a protocol data unit (PDU) session, and a data radio bearer (DRB). The MAC layer of the transmitter module may use a MAC sub-header to indicate whether a corresponding MAC SDU is a segment. The indication manner includes, but not limited to, a 1-bit indication mode and a 2-bit segmentation information (SI) indication mode.

In another embodiment, the MAC layer of the transmitter module adds segment description information in the MAC sub-header of each segment. The segment description information includes but not limited to: a segmentation information (SI); a sequence number (SN); and/or a segment offset (SO). In one embodiment, the MAC layer of a receiver module in the wireless communication system may support reassembly functions, with a reassembly window and a reassembly timer.

As used herein, the term “layer” refers to an abstraction layer of a layered model, e.g. the open systems interconnection (OSI) model, which partitions a communication system into abstraction layers. A layer serves the next higher layer above it, and is served by the next lower layer below it.

In various embodiments, a BS may be referred to as a network side node and can include, or be implemented as, a next Generation Node B (gNB), an E-UTRAN Node B (eNB), a Transmission Reception Point (TRP), an Access Point (AP), a donor node (DN), a relay node, a core network (CN) node, a RAN node, a master node, a secondary node, a distributed unit (DU), a centralized unit (CU), etc. A UE in the present disclosure can be referred to as a terminal and can include, or be implemented as, a mobile station (MS), a station (STA), etc. A BS and a UE may be described herein as non-limiting examples of “wireless communication nodes” or “wireless communication modules”; and a UE may be described herein as non-limiting examples of “wireless communication devices.” The BS and UE can practice the methods disclosed herein and may be capable of wireless and/or wired communications, in accordance with various embodiments of the present disclosure.

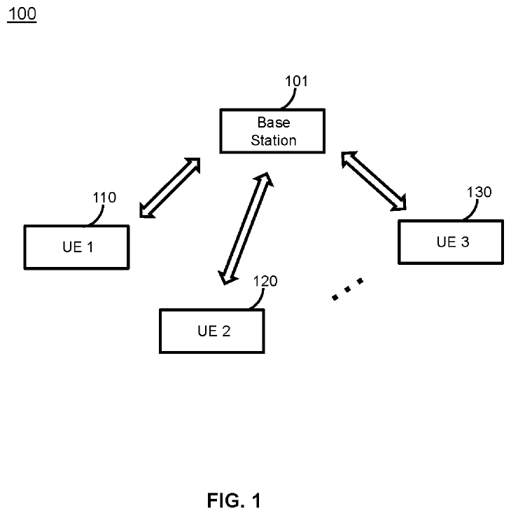

FIG. 1 illustrates an exemplary communication network 100 in which techniques disclosed herein may be implemented, in accordance with an embodiment of the present disclosure. As shown in FIG. 1, the exemplary communication network 100 includes a base station (BS) 101 and a plurality of UEs, UE 1 110, UE 2 120 . . . UE 3 130, where the BS 101 can communicate with the UEs according to wireless protocols. Before a transmitter module, e.g. the BS 101, transmits data, the BS 101 performs data unit segmentation and scheduling functions. These two functions may be integrated closely in a same layer, e.g. the MAC layer, to avoid cross-layer interaction and improve data processing efficiency at the user plane of the BS 101.

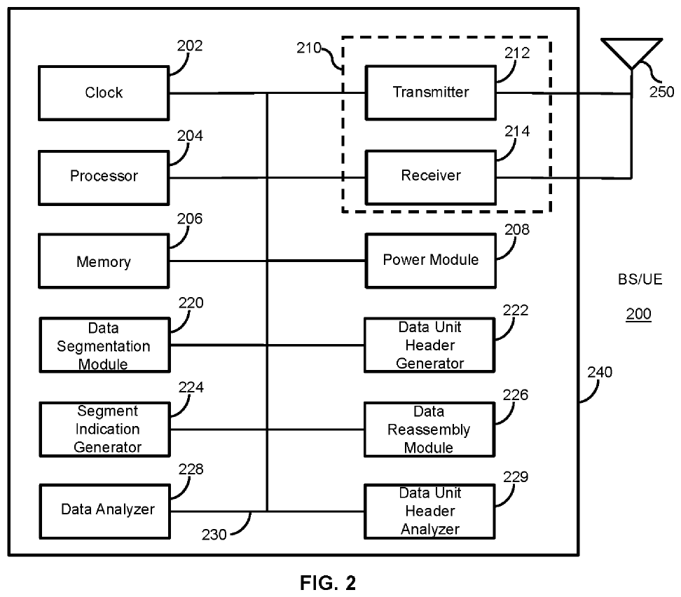

FIG. 2 illustrates a block diagram of a node 200, which may be a base station (BS) and/or a user equipment (UE), in accordance with some embodiments of the present disclosure. The node 200 is an example of a module or device that can be configured to implement the various methods described herein. As shown in FIG. 2, the node 200 includes a housing 240 containing a system clock 202, a processor 204, a memory 206, a transceiver 210 comprising a transmitter 212 and receiver 214, a power module 208, a data segmentation module 220, a data unit header generator 222, a segment indication generator 224, a data reassembly module 226, a data analyzer 228, and a data unit header analyzer 229.

In this embodiment, the system clock 202 provides the timing signals to the processor 204 for controlling the timing of all operations of the node 200. The processor 204 controls the general operation of the node 200 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 206, which can include both read-only memory (ROM) and random access memory (RAM), can provide instructions and data to the processor 204. A portion of the memory 206 can also include non-volatile random access memory (NVRAM). The processor 204 typically performs logical and arithmetic operations based on program instructions stored within the memory 206. The instructions (a.k.a., software) stored in the memory 206 can be executed by the processor 204 to perform the methods described herein. The processor 204 and memory 206 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 210, which includes the transmitter 212 and receiver 214, allows the node 200 to transmit and receive data to and from a remote device (e.g., the BS or another UE). An antenna 250 is typically attached to the housing 240 and electrically coupled to the transceiver 210. In various embodiments, the node 200 includes (not shown) multiple transmitters, multiple receivers, and multiple transceivers. In one embodiment, the antenna 250 is replaced with a multi-antenna array 250 that can form a plurality of beams each of which points in a distinct direction. The transmitter 212 can be configured to wirelessly transmit packets having different packet types or functions, such packets being generated by the processor 204. Similarly, the receiver 214 is configured to receive packets having different packet types or functions, and the processor 204 is configured to process packets of a plurality of different packet types. For example, the processor 204 can be configured to determine the type of packet and to process the packet and/or fields of the packet accordingly.

In a wireless communication, the node 200 may serve either as a transmitter module or as a receiver module. When serving as a transmitter module, the data segmentation module 220 of the node 200 may segment a plurality of data units from a plurality of logical channels into a plurality of data segments at a MAC layer. The plurality of data segments are allocated with a plurality of sequence numbers in sequential order at the MAC layer. For example, a data unit from a first one the plurality of logical channels is segmented into data segments that are allocated with SN=1; while a data unit from a second one of the plurality of logical channels is segmented into data segments that are allocated with SN=2. Then if another data unit from the first one the plurality of logical channels is segmented, it may be segmented to data segments that are allocated with SN=3. The allocation of the sequence numbers to the data segments is in sequential order across the plurality of logical channels, regardless from which logical channel each data segment is generated.

In one embodiment, each of the plurality of data units is a MAC service data unit (SDU); and each of the plurality of data segments is a MAC service data unit (SDU) segment. In one embodiment, the sequence numbers of MAC SDU segments are allocated sequentially per MAC entity.

The data segmentation module 220 may obtain, at the MAC layer, the plurality of data units from a layer immediately above the MAC layer, e.g. the RLC layer. The plurality of data units may be grouped by at least one of: a Quality of Service (QoS) flow, a protocol data unit (PDU) session, and a data radio bearer (DRB).

The data unit header generator 222 in this example may add headers or sub-headers to data units. For example, the data unit header generator 222 may add a first header to each of the plurality of data units. The first header comprises an indication indicating whether the data unit comprises a data segment. The first header may comprise a one-bit indicator and/or a two-bit indicator generated by the segment indication generator 224.

The segment indication generator 224 in this example may generate segment indicators to be added in a header or sub-header by the data unit header generator 222. In one embodiment, the segment indication generator 224 may generate a one-bit indicator and set the one-bit indicator in the first header of each of the at least one data unit to a value which indicates that the data unit comprises a data segment. In another embodiment, the segment indication generator 224 may generate a two-bit indicator and set the two-bit indicator in the first header of each of the at least one data unit to a value which indicates that the data unit comprises a data segment and indicates a location of the data segment with respect to the data unit.

In one embodiment, the data unit header generator 222 may also add a second header to each of the plurality of data segments. The second header comprises description information related to the data segment. For example, the description information comprises at least one of: a segmentation information (SI); a sequence number (SN); and a segment offset (SO).

In one embodiment, as a transmitter module, the node 200 may transmit, via the transmitter 212, a plurality of segmented data units to a receiver module. The plurality of segmented data units is generated by the segmenting. Each of the transmitter module and the receiver module is either one of: a BS and a UE in the wireless communication system, according to various embodiments.

On the other hand, when the node serves as a receiver module, the data reassembly module 226 of the node 200 may reassemble a plurality of data segments at a medium access control (MAC) layer to construct at least one of a plurality of data units for a plurality of logical channels. The plurality of data segments are allocated with a plurality of sequence numbers (SNs) in sequential order at the MAC layer. In one embodiment, each of the plurality of data units is a MAC service data unit (SDU); and each of the plurality of data segments is a MAC SDU segment. After the reassembly, the data reassembly module 226 may send the plurality of data units based on their respective logical channels to a layer immediately above the MAC layer, e.g. the RLC layer. The plurality of data units may be grouped by at least one of: a Quality of Service (QoS) flow, a protocol data unit (PDU) session, and a data radio bearer (DRB).

The data analyzer 228 in this example may receive, via the receiver 214, at least one protocol data unit (PDU) from a transmitter module in the wireless communication system. Each of the transmitter module and the receiver module may be either a BS or a UE according to various embodiments. The data analyzer 228 may analyze the at least one PDU to obtain a plurality of sub-PDUs. The data analyzer 228 can send the sub-PDUs to the data unit header analyzer 229 for further analysis.

In one embodiment, the data unit header analyzer 229 in this example may read and analyze a first header of each of the plurality of sub-PDUs. Based on an indication in the first header of a sub-PDU, the data unit header analyzer 229 may identify that the sub-PDU is a data segment for a data unit. In one embodiment, the data reassembly module 226 may determine that all data segments for the data unit are identified before an expiration of a timer that is configured for the reassembling; and reassemble the data segments to construct the data unit.

In another embodiment, the data unit header analyzer 229 may read and analyze a second header of the sub-PDU. The second header comprises description information related to the data segment. In one example, the indication in the first header comprises a one-bit indicator. The description information in the second header comprises at least one of: a segmentation information (SI); a sequence number (SN); and a segment offset (SO). In another example, the indication in the first header comprises a two-bit indicator. Based on the indication in the first header, the data unit header analyzer 229 may determine a location of the data segment with respect to the data unit. The description information in the second header comprises at least one of: a sequence number (SN); and a segment offset (SO).

The power module 208 can include a power source such as one or more batteries, and a power regulator, to provide regulated power to each of the above-described modules in FIG. 2. In some embodiments, if the node 200 is coupled to a dedicated external power source (e.g., a wall electrical outlet), the power module 208 can include a transformer and a power regulator.

The various modules discussed above are coupled together by a bus system 230. The bus system 230 can include a data bus and, for example, a power bus, a control signal bus, and/or a status signal bus in addition to the data bus. It is understood that the modules of the node 200 can be operatively coupled to one another using any suitable techniques and mediums.

Although a number of separate modules or components are illustrated in FIG. 2, persons of ordinary skill in the art will understand that one or more of the modules can be combined or commonly implemented. For example, the processor 204 can implement not only the functionality described above with respect to the processor 204, but also implement the functionality described above with respect to the data segmentation module 220. Conversely, each of the modules illustrated in FIG. 2 can be implemented using a plurality of separate components or elements.

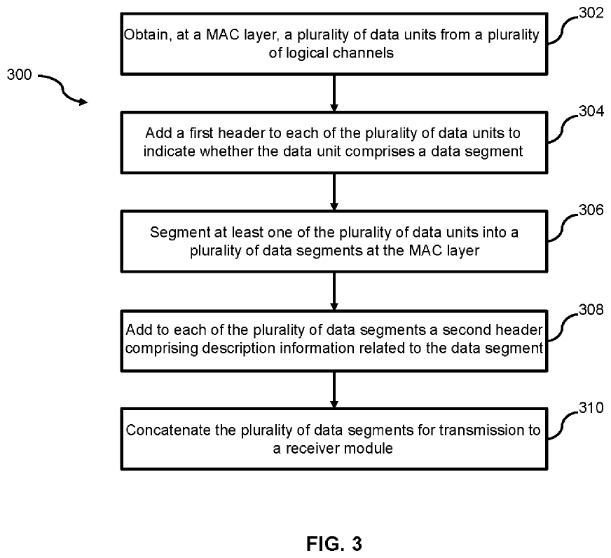

FIG. 3 illustrates a flow chart for a method 300 performed by a wireless communication node, e.g. the node 200 in FIG. 2, for data segmentation as a transmitter module, in accordance with some embodiments of the present disclosure. At operation 302, a plurality of data units are obtained at a MAC layer from a plurality of logical channels. At operation 304, a first header is added to each of the plurality of data units to indicate whether the data unit comprises a data segment. At operation 306, at least one of the plurality of data units is segmented into a plurality of data segments at the MAC layer. At operation 308, a second header comprising description information related to the data segment is added to each of the plurality of data segments. At operation 310, the plurality of data segments are concatenated for transmission to a receiver module. The order of the operations shown in FIG. 3 may be changed according to different embodiments of the present disclosure.

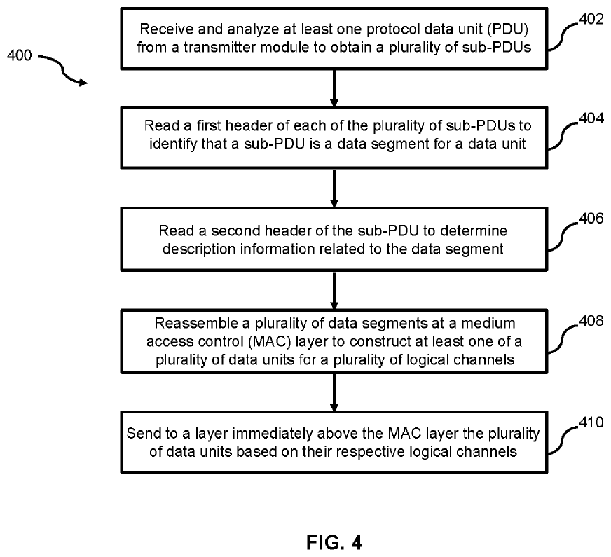

FIG. 4 illustrates a flow chart for a method 400 performed by a wireless communication node, e.g. the node 200 in FIG. 2, for data reassembly as a receiver module, in accordance with some embodiments of the present disclosure. At operation 402, at least one protocol data unit (PDU) is received and analyzed from a transmitter module to obtain a plurality of sub-PDUs. At operation 404, a first header is read for each of the plurality of sub-PDUs to identify that a sub-PDU is a data segment for a data unit. At operation 406, a second header of the sub-PDU is read to determine description information related to the data segment. At operation 408, a plurality of data segments are reassembled at a MAC layer to construct at least one of a plurality of data units for a plurality of logical channels at the MAC layer. At operation 410, the plurality of data units is sent to a layer immediately above the MAC layer based on their respective logical channels. The order of the operations shown in FIG. 4 may be changed according to different embodiments of the present disclosure.

Different embodiments of the present disclosure will now be described in detail hereinafter. It is noted that the features of the embodiments and examples in the present disclosure may be combined with each other in any manner without conflict.

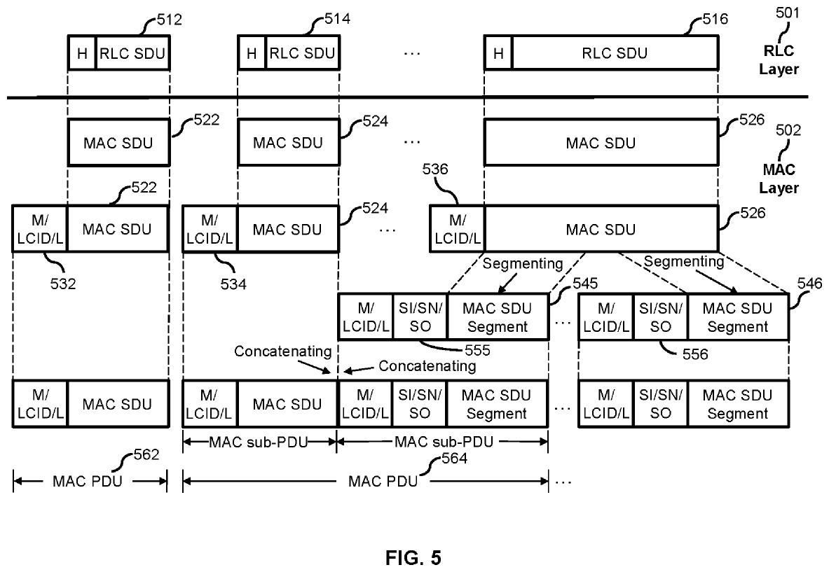

In a first embodiment, a method is disclosed for data segmentation at the MAC layer based on a one-bit segment indicator. FIG. 5 illustrates an exemplary method for data segmentation at a medium access control (MAC) layer, in accordance with the first embodiment. The method may comprise the following exemplary steps.

In Step 1, the RLC layer 501 of a transmitting side or a transmitter module delivers the grouped RLC PDUs data packets 512, 514, 516 to the MAC layer 502 through a logical channel. The data packets that the RLC layer 501 delivers to the MAC layer 502 may be at a flow level, a PDU session level, or a DRB level.

In Step 2, the MAC layer 502 of the transmitting side adds a sub-header 532, 534, 536 to each MAC SDU 522, 524, 526. The sub-header 532, 534, 536 mainly includes the logical channel ID (LCD), the length (L) of the MAC SDU, and a 1-bit segment indication information indicating whether a segment sub-header is included in the MAC SDU, or whether the MAC SDU is a segment. For example, the 1-bit segment indication may be in the M field in the sub-header 532, 534, 536. At this step, the MAC layer does not fill in a valid value for the segment indication bit M. That is, M has a value R, representing reserved at this step.

In Step 3, the MAC layer 502 of the transmitting side comprehensively considers the data packet conditions of all logical channels based on the current scheduling result at the MAC layer 502. The MAC layer 502 may segment the MAC SDUs, which need to be segmented, to generate MAC SDU segments; and add a segment sub-header to each MAC SDU segment. For example, as shown in FIG. 5, the MAC SDU 526 is segmented into two or more MAC SDU segments 545, 546. A segment sub-header 555 is added to the MAC SDU segment 545; and a segment sub-header 556 is added to the MAC SDU segment 546. Each segment sub-header may mainly include fields indicating segment-related description information. For example, the fields may include: a segmentation information (SI) for indicating a segmentation type, which may be a first segment, a last segment, or a middle segment; a segment number (SN); and a segment offset (SO). In addition, at this step, the MAC layer also sets a valid value (e.g. a value set to 1 for a segment) to the segment indication bit M in the MAC sub-header of each segmented data unit. For example, after segmentation, the MAC SDUs 522, 524 and the MAC SDU segments 545, 546 are all segmented data units. Each segmented data unit may be part of a MAC sub-PDU or a MAC PDU. The bit M in the MAC sub-header of each of the MAC SDUs 522, 524 may be set to 0 to indicate that the MAC SDUs 522, 524 are not segments. The bit M in the MAC sub-header of each of the MAC SDU segments 545, 546 may be set to 1 to indicate that the MAC SDU segments 545, 546 are segments. The segmentation at the MAC layer enables the MAC layer to segment data packet in time based on its own scheduling situation, without a need of cross-layer interaction, which improves data processing efficiency at the user plane.

In Step 4, the MAC layer 502 of the transmitting side concatenates the MAC sub-PDUs to form MAC PDUs, and sends the MAC PDUs to the PHY layer. In one example, as shown in FIG. 5, two MAC sub-PDUs, including the MAC SDU 524 and the MAC SDU segment 545 are concatenated to form the MAC PDU 564. Some MAC SDU, e.g. the MAC SDU 522, may form a MAC PDU 562 by itself.

In Step 5, the PHY layer of the transmitting side sends the processed transport blocks (TBs) to a receiving side or a receiver module through an air interface.

In Step 6, the PHY layer of the receiving side receives the TBs sent by the transmitting side, and performs PHY layer processing. Then the PHY layer of the receiving side delivers the MAC PDUs to the MAC layer.

In Step 7, the MAC layer of the receiving side analyzes and parses the MAC PDUs. By reading the segment indication information M in the MAC sub-header, the MAC layer of the receiving side determines whether there is a segment sub-header after the MAC sub-header, based on whether the M in the MAC sub-header is 1. For a MAC sub-PDU segment with the segment indication bit M equals 1, the MAC layer further analyzes and parses the SI/SN/SO information in the segment sub-header to determine the segment type, sequence number, and segment offset, of the segment. When all segments of an SN are all collected before a reassembly timer expires, the MAC layer reassembles all segments of the SN to generate a reassembled MAC SDU corresponding to a logical channel. The MAC layer sends the reassembled MAC SDUs to the RLC layer through their respective corresponding logical channels with a LCID. Here, all LCIDs associated with a same SN should have a same value. For a MAC sub-PDU segment with the segment indication bit M equals 0, the MAC layer of the receiving side de-multiplexes the MAC SDUs in each logical channel from the MAC PDUs, and sends the MAC SDUs to the RLC layer through their corresponding logical channels according to their respective LCD information in their respective sub-headers.

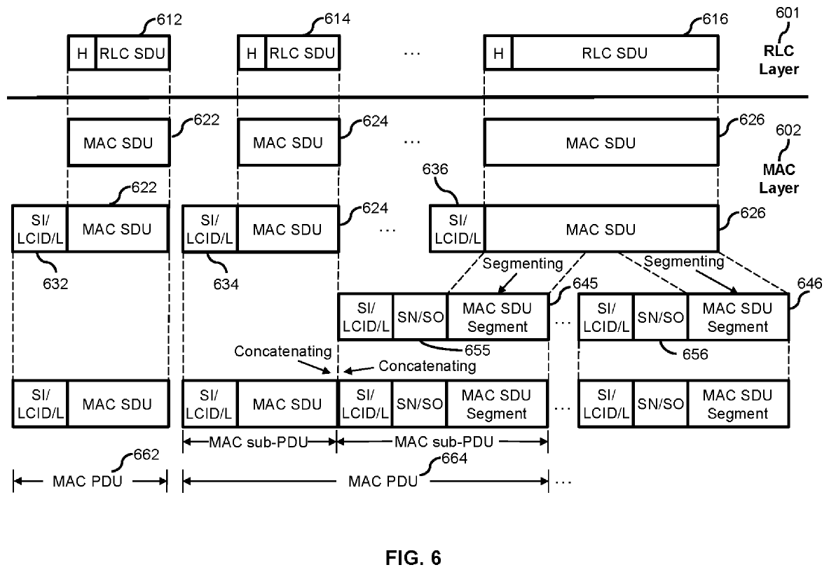

In a second embodiment, a method is disclosed for data segmentation at the MAC layer based on a two-bit segment indicator. FIG. 6 illustrates an exemplary method for data segmentation at a medium access control (MAC) layer, in accordance with the second embodiment. The method may comprise the following exemplary steps.

In Step 1, the RLC layer 601 of a transmitting side or a transmitter module delivers the grouped RLC PDUs data packets 612, 614, 616 to the MAC layer 602 through a logical channel. The data packets that the RLC layer 601 delivers to the MAC layer 602 may be at a flow level, a PDU session level, or a DRB level.

In Step 2, the MAC layer 602 of the transmitting side adds a sub-header 632, 634, 636 to each MAC SDU 622, 624, 626. The sub-header 632, 634, 636 mainly includes the logical channel ID (LCID), the length (L) of the MAC SDU, and a 2-bit segment type indication information. For example, the 2-bit segment type indication information may be in the SI field in the sub-header 632, 634, 636. At this step, the MAC layer does not fill in a valid value for the segment type indication information SI. That is, SI has a value R, representing reserved at this step.

In Step 3, the MAC layer 602 of the transmitting side comprehensively considers the data packet conditions of all logical channels based on the current scheduling result at the MAC layer 602. The MAC layer 602 may segment the MAC SDUs, which need to be segmented, to generate MAC SDU segments; and add a segment sub-header to each MAC SDU segment. For example, as shown in FIG. 6, the MAC SDU 626 is segmented into two or more MAC SDU segments 645, 646. A segment sub-header 655 is added to the MAC SDU segment 645; and a segment sub-header 656 is added to the MAC SDU segment 646. Each segment sub-header may mainly include fields indicating segment-related description information. For example, the fields may include: a segment number (SN) and/or a segment offset (SO). In addition, at this step, the MAC layer also sets a valid value to the segment type indication information SI in the MAC sub-header of each segmented data unit. For example, a value of 00 indicates a whole message without segmentation; a value of 01 indicates a first segment; a value of 10 indicates a middle segment; and a value of 11 indicates a last segment.

For example, after segmentation, the MAC SDUs 622, 624 and the MAC SDU segments 645, 646 are all segmented data units. Each segmented data unit may be part of a MAC sub-PDU or a MAC PDU. The segment type indication information SI in the MAC sub-header of each of the MAC SDUs 622, 624 may be set to 00 to indicate that the MAC SDUs 622, 624 are not segments. The segment type indication information SI in the MAC sub-header of each of the MAC SDU segment 645 may be set to 01 to indicate that the MAC SDU segment is a first segment in the MAC SDU. The segment type indication information SI in the MAC sub-header of each of the MAC SDU segment 646 may be set to 11 to indicate that the MAC SDU segment is a last segment in the MAC SDU. The segmentation at the MAC layer enables the MAC layer to segment data packet in time based on its own scheduling situation, without a need of cross-layer interaction, which improves data processing efficiency at the user plane.

In Step 4, the MAC layer 602 of the transmitting side concatenates the MAC sub-PDUs to form MAC PDUs, and sends the MAC PDUs to the PHY layer. In one example, as shown in FIG. 6, two MAC sub-PDUs, including the MAC SDU 624 and the MAC SDU segment 645 are concatenated to form the MAC PDU 664. Some MAC SDU, e.g. the MAC SDU 622, may form a MAC PDU 662 by itself.

In Step 5, the PHY layer of the transmitting side sends the processed transport blocks (TBs) to a receiving side or a receiver module through an air interface.

In Step 6, the PHY layer of the receiving side receives the TBs sent by the transmitting side, and performs PHY layer processing. Then the PHY layer of the receiving side delivers the MAC PDUs to the MAC layer.

In Step 7, the MAC layer of the receiving side analyzes and parses the MAC PDUs. By reading the segment type indication information SI in the MAC sub-header, the MAC layer of the receiving side determines whether there is a segment sub-header after the MAC sub-header, based on whether the SI in the MAC sub-header is 01, 10, or 11. For a MAC sub-PDU segment with the segment type indication information SI equals 01, 10, or 11, the MAC layer further analyzes and parses the SN and SO information in the segment sub-header to determine the sequence number and segment offset of the segment. When all segments of an SN are all collected before a reassembly timer expires, the MAC layer reassembles all segments of the SN to generate a reassembled MAC SDU corresponding to a logical channel. The MAC layer sends the reassembled MAC SDUs to the RLC layer through their respective corresponding logical channels with a LCID. Here, all LCIDs associated with a same SN should have a same value. For a MAC sub-PDU segment with the segment type indication information SI equals 00, the MAC layer of the receiving side de-multiplexes the MAC SDUs in each logical channel from the MAC PDUs, and sends the MAC SDUs to the RLC layer through their corresponding logical channels according to their respective LCID information in their respective sub-headers.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method performed by a transmitter module in a wireless communication system, the method comprising:
segmenting a plurality of data units from a plurality of logical channels into a plurality of data segments at a medium access control (MAC) layer,
wherein the plurality of data segments are allocated with a plurality of sequence numbers in sequential order.

2. The method of claim 1, wherein each of the plurality of data units is a MAC service data unit (SDU).

3. The method of claim 1, wherein each of the plurality of data segments is a MAC service data unit (SDU) segment.

4. The method of claim 1, further comprising:
obtaining, at the MAC layer, the plurality of data units from a layer immediately above the MAC layer, wherein the plurality of data units are grouped by at least one of: a Quality of Service (QoS) flow, a protocol data unit (PDU) session, and a data radio bearer (DRB).

5. The method of claim 1, further comprising:
adding a first header to each of the plurality of data units, wherein the first header comprises an indication indicating whether the data unit comprises a data segment.

6. The method of claim 5, wherein the first header comprises at least one of:
a one-bit indicator; and
a two-bit indicator.

7. The method of claim 6, further comprising:
setting the one-bit indicator in the first header of each of the at least one data unit to a value to indicate that the data unit comprises a data segment.

8. The method of claim 6, further comprising:
setting the two-bit indicator in the first header of each of the at least one data unit to a value to indicate that the data unit comprises a data segment and indicate a location of the data segment with respect to the data unit.

9. The method of claim 1, further comprising:
adding a second header to each of the plurality of data segments, wherein the second header comprises description information related to the data segment, wherein the description information comprises at least one of:
a segmentation information (SI);
a sequence number (SN); or
a segment offset (SO).

10. A method performed by a receiver module in a wireless communication system, the method comprising:
reassembling a plurality of data segments at a medium access control (MAC) layer to construct at least one of a plurality of reassembled data units for a plurality of logical channels,
wherein the plurality of data segments are allocated with a plurality of sequence numbers in sequential order.

11. The method of claim 10, wherein each of the plurality of reassembled data units is a MAC service data unit (SDU).

12. The method of claim 10, wherein each of the plurality of data segments is a MAC service data unit (SDU) segment.

13. The method of claim 10, further comprising:
sending, to a layer immediately above the MAC layer, the plurality of reassembled data units based on their respective logical channels, wherein the plurality of reassembled data units are grouped by at least one of: a Quality of Service (QoS) flow, a protocol data unit (PDU) session, and a data radio bearer (DRB).

14. The method of claim 10, further comprising:
receiving at least one protocol data unit (PDU) from a transmitter module in the wireless communication system;
analyzing the at least one PDU to obtain a plurality of sub-PDUs;
reading a first header of each of the plurality of sub-PDUs; and
identifying, based on an indication in the first header of a sub-PDU, that the sub-PDU is a data segment for a data unit.

15. The method of claim 14, further comprising:
reading a second header of the sub-PDU, wherein the second header comprises description information related to the data segment.

16. The method of claim 15, wherein:
the indication in the first header comprises a one-bit indicator; and
the description information comprises at least one of:
a segmentation information (SI);
a sequence number (SN); and
a segment offset (SO).

17. The method of claim 15, further comprising determining, based on the indication in the first header, a location of the data segment with respect to the data unit, wherein:
the indication in the first header comprises a two-bit indicator; and
the description information comprises at least one of:
a sequence number (SN); and
a segment offset (SO).

18. A wireless communication node, comprising:
at least one processor configured to:
segment a plurality of data units from a plurality of logical channels into a plurality of data segments at a medium access control (MAC) layer,
wherein the plurality of data segments are allocated with a plurality of sequence numbers in sequential order.

19. A wireless communication device, comprising:
at least one processor configured to:
reassemble a plurality of data segments at a medium access control (MAC) layer to construct at least one of a plurality of reassembled data units for a plurality of logical channels,
wherein the plurality of data segments are allocated with a plurality of sequence numbers in sequential order.

20. A non-transitory computer-readable medium having stored thereon computer-executable instructions which when executed cause at least one processor to:
segment a plurality of data units from a plurality of logical channels into a plurality of data segments at a medium access control (MAC) layer,
wherein the plurality of data segments are allocated with a plurality of sequence numbers in sequential order.
